(19) United States
(12) Patent Application Publication
(10) Pub. No.: US 2006/0257014 A1
(43) Pub. Date: Nov. 16, 2006

(54) Register mark reader for cutting plotter and register mark reading method

(75) Inventor: Hiroyoshi Oi, Nagano (JP)

Correspondence Address: SNELL & WILMER LLP, 600 ANTON BOULEVARD, SUITE 1400, COSTA MESA, CA, 92626, US

(73) Assignee: MIMAKI ENGINEERING CO., LTD., Nagano (JP)

(21) Appl. No.: 10/558,866

(22) PCT Filed: Jul. 15, 2003
(86) PCT No.: PCT/JP03/08997

§ 371 Date: Nov. 30, 2005

(51) Int. Cl. G06K 9/00

(52) U.S. Cl. 382/141

(57) ABSTRACT

A head (30) of a cutting plotter is rapidly moved to a position above or near a portion where a register mark is printed on a medium (50) mounted on a platen (20) relatively in a X-Y direction above the medium (50) without taking a waste time by effectively using data on the position of the register mark stored in data storage means (80) for register mark printing. Then the head (30) is moved slowly above the medium (50) relatively in a X-Y direction to reliably read the register mark printed on the medium (50) by means of an optical read sensor mounted on the head (30) without failing to read it. Thus, the time required to read the position of the register mark printed on the medium (50) can be greatly reduced.

### TECHNICAL FIELD

The present invention relates to a register mark reader for cutting plotter, that reads a register mark (a mark for positional registering and for positioning) printed on a surface of a medium, such as sheet or the like, together with a picture or/and a character, of which a profile is to be cut by a cutting plotter, and a register mark reading method using the reader.

### BACKGROUND ART

A cutting plotter is known to automatically cut a profile of a picture or/and a character printed on a surface of a medium such as a sheet or the like.

When such a cutting plotter is used to cut a profile 54 of a picture or/and a character printed on a surface of a medium 50 as shown in FIG. 4, an optical sensor mounted on a head of the cutting plotter is used to read positional information of register marks 56 printed at four corners, etc. of a surface of the same medium 50 as that surface of the medium 50 mounted on the platen, on which a picture or/and a character 52 is printed. A host computer for driving of the cutting plotter is caused to recognize an origin position of the picture or/and the character 52 printed on the surface of the medium 50 mounted on the platen and inclination and elongation of the picture or/and the character in a X-Y direction (length and width) from the positional information of the register marks 56 read with the use of the optical sensor. According to the origin position of the picture or/and the character 52 printed on the surface of the medium 50 and inclination and elongation of the picture or/and the character in the X-Y direction (length and width), which are recognized by the host computer, the cutting plotter cuts the profile 54 of a picture or/and a character printed on a surface of the same medium 50 as the surface of the medium 50, on which the register marks 56 are printed. The picture or/and the character 52 is printed on the surface of the same medium 50 with the register marks 56 printed on the surface of the medium 50 as a reference. The register marks 56 are composed of L-shaped, cross-shaped, or like thin lines.

When the optical sensor mounted on the head is used to read the register marks 56 printed at four corners, etc. of the surface of the medium 50, the head of the cutting plotter is moved above the platen substantially in parallel to a surface of the platen relatively in the X-Y direction. Then the optical sensor mounted on the head is caused to recognize the register marks 56 printed on the surface of the medium 50 mounted on the platen. The optical sensor is formed by combining a light emitting element and a light receiving element such that light emitted from the light emitting element is reflected on the surface of the medium to be received by the light receiving element. A change in quantity of light received by the light receiving element is analyzed by an electronic circuit of the host computer or the like so that positions of the register marks 56 printed on the surface of the medium 50 can be read.

However, a considerable amount of time is taken when the optical sensor mounted on the head is used to read positions of the register marks 56 printed at four corners, etc. of the surface of the medium 50.

The reason for this is that when it is tried to cause the optical sensor mounted on the head to surely read the register marks 56 composed of thin lines and printed on the surface of the medium 50 mounted on the platen without oversight, it is necessary to move the head above the platen relatively in the X-Y direction at slow speed. Therefore, it takes a considerable amount of time to cause the head provided with the optical sensor to move above the medium 50 mounted on the platen relatively in the X-Y direction to above those locations on the surface of the medium 50, in which the register marks 56 are printed.

As a result, time required for using the cutting plotter to cut the profile 54 of a picture or/and a character printed on the surface of the medium 50 is considerably extended.

It is an object of the invention to provide a register mark reader for a cutting plotter (referred below simply to as register mark reader), that uses an optical sensor mounted on a head to be able to surely and rapidly read a register mark printed on a surface of a medium by means of optical read means without spending time and without oversight, and a register mark reading method (referred below simply to as register mark reading method) using a register mark reader for a cutting plotter, the method using an optical sensor mounted on a head to be able to surely and rapidly read a register mark printed on a surface of a medium by means of optical read means without spending time and without oversight.

### DISCLOSURE OF THE INVENTION

In order to attain the object, a register mark reader according to the invention has a feature in

a cutting plotter according to the invention, in which on the basis of that positional information of a register mark printed on a surface of a medium mounted on a platen, which is read by means of an optical sensor mounted on a head being moved above the platen substantially in parallel to a surface of the platen relatively in a X-Y direction (length and width), the head is moved above the platen substantially in the X-Y direction to permit a cutter mounted on the head to cut a profile of a picture or/and a character printed on the same surface of the medium as that, which is mounted on the platen and on which the register mark is printed,

the cutting plotter comprising retrieval means that retrieves positional data of a register mark stored in data storage means for printing of the register mark and printed on the surface of the medium together with a picture or/and a character with the use of the same software as that for printing of the picture or/and the character, of which a profile is to be cut by the cutting plotter,

moving means, by which a register mark indicative of an origin position of the picture or/and the character printed on the surface of the medium is caused to overlap an origin position of, or near the platen on the basis of positional data of a register mark retrieved by the retrieval means, a X-Y axis of the picture or/and the character printed on the surface of the medium is caused to overlap a X-Y axis of, or near the platen to permit the head of the cutting plotter to move above the medium mounted on the platen relatively in the X-Y direction, and the head is moved to above or near that location on the surface of the medium mounted on the platen, in which the register mark is printed, and

register mark read means, by which the head having been moved to above or near that location on the surface of the medium, in which a register mark is printed, by the moving means is moved above the platen relatively in the X-Y direction at such a speed that the optical sensor mounted on the head can recognize the register mark, and the optical sensor mounted on the head is used to read a position of the register mark printed on the surface of the medium.

A register mark reading method, according to the invention, using the register mark reader according to the invention comprises

a first step, in which a medium having a register mark printed thereon together with a picture or/and a character, of which a profile is to be cut, is mounted on the platen of the cutting plotter provided with the register mark reader according to the invention to cause a register mark indicative of an origin position of the picture or/and the character printed on a surface of the medium to overlap an origin position of, or near the platen, and a X-Y axis of the picture or/and the character printed on the surface of the medium is caused to overlap a X-Y axis of, or near the platen,

a second step, in which the retrieval means of the register mark reader according to the invention uses the same software as that for printing of a picture or/and a character, of which a profile is to be cut by the cutting plotter, to retrieve positional data of a register mark stored in data storage means for printing of register marks and printed on the surface of the medium together with the picture or/and the character,

a third step, in which a register mark indicative of an origin position of the picture or/and the character printed on the surface of the medium is caused by the moving means of the register mark reader according to the invention to overlap the origin position of, or near the platen on the basis of positional data of a register mark retrieved by the retrieval means, a X-Y axis of the picture or/and the character printed on the surface of the medium is caused to overlap the X-Y axis of, or near the platen, and the head is moved above the medium mounted on the platen relatively in the X-Y direction to be moved to above or near that location on the surface of the medium mounted on the platen, in which the register mark is printed, and

a fourth step, in which the head having been moved to above or near that location on the surface of the medium, in which the register mark is printed, by the moving means is moved above the platen relatively in the X-Y direction with the use of the register mark read means of the register mark reader according to the invention at such a speed that the optical sensor mounted on the head can recognize the register mark, and the optical sensor mounted on the head is used to read a position of the register mark printed on the surface of the medium.

In the register mark reading method using the register mark reader constructed in this manner,

a medium having a register mark printed thereon together with a picture or/and a character, of which a profile is to be cut, is mounted on the platen of the cutting plotter provided with the register mark reader, to enable causing a register mark indicative of an origin position of the picture or/and the character printed on a surface of the medium to overlap an origin position of the platen of the cutting plotter, or near thereto in a first step thereof. Along with this, it is possible to cause a X-Y axis of the picture or/and the character printed on the surface of the medium to overlap a X-Y axis of the platen, or near thereto. That is, it is possible to cause an origin position of the picture or/and the character printed on the surface of the medium to correspond substantially to an origin position of the platen of the cutting plotter and to cause a X-Y axis of the picture or/and the character printed on the surface of the medium to correspond substantially to a X-Y axis of the platen of the cutting plotter.

Subsequently, it is possible in the second step with the use of the retrieval means of register mark reader to use the same software as that for printing of a picture or/and a character to retrieve positional data of a register mark stored in data storage means for printing of register marks and printed on the surface of the medium together with the picture or/and the character.

Subsequently, in the third step, a register mark indicative of an origin position of the picture or/and the character printed on the surface of the medium is caused by the moving means of the register mark reader to overlap the origin position of the platen, or near thereto on the basis of positional data of a register mark retrieved by the retrieval means, a X-Y axis of the picture or/and the character printed on the surface of the medium is caused to overlap the X-Y axis of the platen, or near thereto, and the head of the cutting plotter is moved above the medium mounted on the platen relatively in the X-Y direction and can be moved to above or near that location on the surface of the medium mounted on the platen, in which the register mark is printed. At this time, since it is unnecessary for the optical sensor mounted on the head of the cutting plotter to recognize a register mark printed on the surface of the medium, the head of the cutting plotter can be moved above the platen to above or near that location on the surface of the medium mounted on the platen, in which the register mark is printed, relatively in the X-Y direction at high speed without spending time on the basis of positional data of the register mark retrieved by the retrieval means.

Thereafter, in the fourth step, the head having been moved to above or near that location on the surface of the medium, in which the register mark is printed, by the moving means can be moved above the platen relatively in the X-Y direction with the use of the register mark read means of the register mark reader at such a slow speed that the optical sensor mounted on the head can surely recognize the register mark. Then it is possible to cause the optical sensor mounted on the head to surely recognize the register mark printed on the surface of the medium without oversight. On the basis of results of recognition by the optical sensor, a position of the register mark printed on the surface of the medium can be surely read at all times by the register mark read means of the register mark reader without oversight.

That is, in the register mark reading method using the register mark reader, positional data of a register mark stored in data storage means for printing of register marks and printed on the surface of the medium together with the picture or/and the character with the use of the same software as that for printing of a picture or/and a character are made effective use of to enable moving rapidly the head of the cutting plotter above the platen to above or near that location on the surface of the medium, in which the register mark is printed, relatively in the X-Y direction without spending time. Subsequently, the head having been moved to above or near that location on the surface of the medium, in which the register mark is printed, can be slowly moved above the medium mounted on the platen spending time relatively in the X-Y direction at such a speed that the optical sensor mounted on the head is used to enable surely recognizing the register mark printed on the surface of the medium. Then the optical sensor mounted on the head is used to enable the register mark read means to read a position of the register mark printed on the surface of the medium without oversight. As a result, time required for reading a position of the register mark printed on the surface of the medium can be considerably shortened.

### BRIEF DESCRIPTION OF THE DRAWINGS

FIG. 1 is a view illustrating a schematic construction of a cutting plotter provided with a register mark reader according to the invention, FIG. 2 is a partially enlarged, perspective view showing a periphery of a platen of the cutting plotter provided with the register mark reader according to the invention, and FIG. 3 is a view illustrating, in enlarged scale, a construction of a periphery of a head of the cutting plotter provided with the register mark reader according to the invention. FIG. 4 is a plan view showing a medium, on which a picture or/and a character, of which a profile is to be cut, are printed together with register marks.

### BEST MODE FOR CARRYING OUT THE INVENTION

A best mode for carrying out the invention will be described below with reference to the drawings.

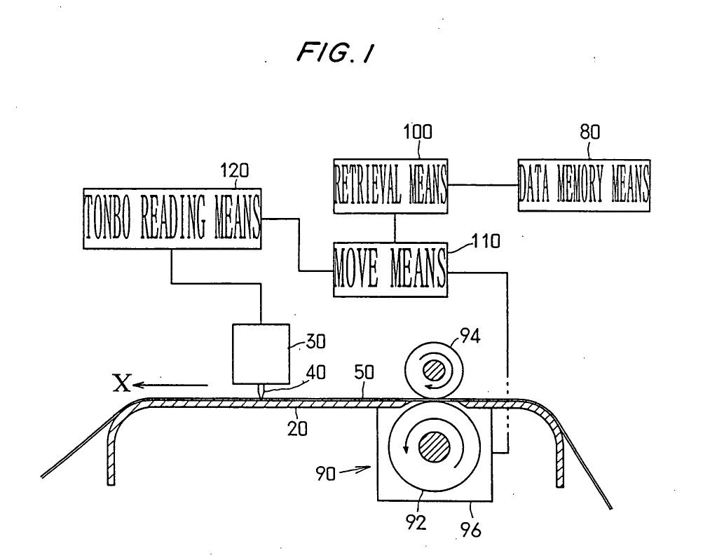

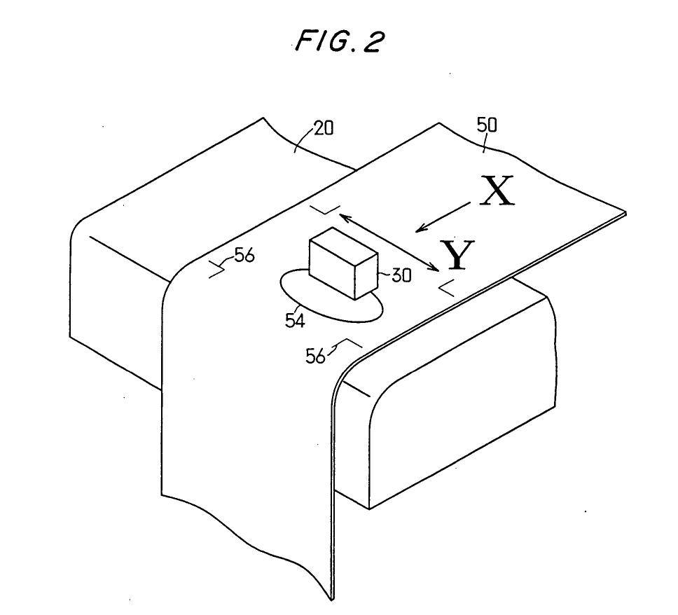

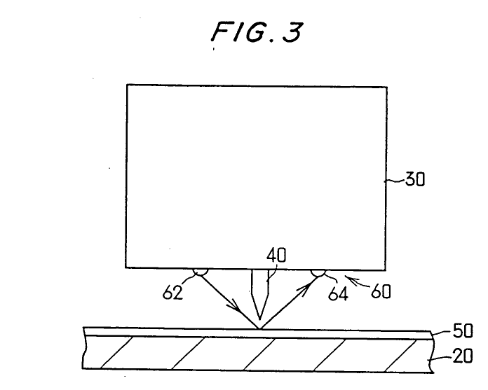

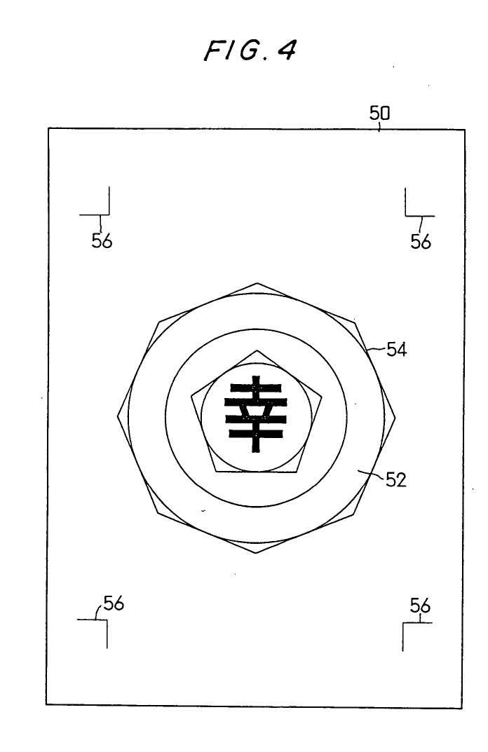

FIGS. 1 and 2 show a cutting plotter, in which a head 30 is moved above a platen 20 relatively in a X-Y direction substantially in parallel to a surface of the platen 20 and a cutter 40 mounted on the head 30 is used to cut a profile 54 of a picture or/and a character printed on a surface of a medium 50 mounted on the platen 20.

The head 30 of the cutting plotter mounts thereon an optical sensor 60 formed by combining a light emitting element 62 such as LED (Light-Emitting Diode) and a light receiving element 64 such as photodiode as shown in FIG. 3. Light emitted from the light emitting element 62 is reflected on the surface of the medium 50 mounted on the platen 20 to be received by the light receiving element 64. A change in quantity of light received by the light receiving element 64 is analyzed by analysis means (not shown) including an electronic circuit of a host computer for driving of the cutting plotter, or the like so that positions of register marks 56 composed of L-shaped, cross-shaped, or like thin lines and printed on the surface of the medium 50, as shown in FIG. 4, mounted on the platen 20 together with the picture or/and the character 52 can be read.

In the cutting plotter, the host computer (not shown) for driving of the cutting plotter is used to enable moving the head 30 above the medium 50 mounted on the platen 20 relatively in a X-Y direction on the basis of positional information of register marks 56 printed on the medium 50, such as sheet or the like, mounted on the platen 20 together with the picture or/and the character 52, the positional information having been read by the optical sensor 60 mounted on the head 30. Specifically, as shown in FIG. 2, it is possible on the basis of the positional information of the register marks 56 to obtain information of an origin position of the picture or/and the character 52 printed on the surface of the medium 50 and inclination and elongation of the picture or/and the character 52 printed on the surface of the medium 50 in a X-Y direction. According to the information of the origin position of and inclination and elongation of the picture or/and the character 52 printed on the surface of the medium 50 in the X-Y direction, it is made possible to move the medium 50 above the platen 20 in a X direction, which corresponds to a longitudinal direction, and to move the head 30 above the medium 50 mounted on the platen 20 in a Y direction, which corresponds to a left and right direction. The profile 54 of the picture or/and the character printed on the surface of the medium 50 as shown in FIG. 4 can be correctly cut by the cutter 40 mounted on the head 30.

While the construction described above is the same as that of conventional cutting plotters, the cutting plotter shown in FIGS. 1 to 3 comprises retrieval means 100 that retrieves positional data of the register marks 56 stored in data storage means 80 for printing of register marks and printed on the surface of the medium 50 together with the picture or/and the character 52 by a printer provided separately from the cutting plotter with the use of the same software as that for creation of design for printing of a picture or/and a character, for creation of illustration, for creation of CAD drawings, or the like. The data storage means 80 and the retrieval means 100 comprise memory elements, an electronic circuit, etc. of host computer for driving of the cutting plotter, which is common to a host computer for driving of the printer.

Also, moving means 110 is provided, by which a register mark 56 indicative of an origin position of a picture or/and a character 52 printed on the surface of the medium 50 is caused to overlap an origin position of the platen 20, or near thereto on the basis of positional data of register marks 56 retrieved by the retrieval means 100, a X-Y axis of the picture or/and the character 52 printed on the surface of the medium 50 is caused to overlap a X-Y axis of the platen 20, or near thereto to permit the head 30 of the cutting plotter to move above the medium 50 mounted on the platen 20 relatively in the X-Y direction, and the head 30 is moved to above or near those locations on the surface of the medium 50 mounted on the platen 20, in which the register marks 56 are printed. The moving means 110 comprises an electric motor (not shown) for driving of the head 30, a feed roller 92 that moves the medium 50 above the platen 20 in the X direction, medium transport means 90 comprising a combination of a pressing roller 94, an electric motor 96, etc., and an electronic circuit, etc. of the host computer for control of drive thereof.

Further, register mark read means 120 is provided, by which the head 30 having been moved to above or near those locations on the surface of the medium 50, in which the register marks 56 are printed, by the moving means 110 is moved above the platen 20 relatively in the X-Y direction at such a slow speed that the optical sensor 60 mounted on the head can surely recognize the register marks 56, and the optical sensor 60 mounted on the head 30 is used to read positions of the register marks 56 printed on the surface of the medium 50 mounted on the platen 20. The register mark read means 120 comprises the electric motor for driving of the head 30, the medium transport means 90 that moves the medium 50 above the platen 20 in the X direction, an electronic circuit (not shown) of the host computer for control of driving of them, the optical sensor 60 mounted on the head 30, an electronic circuit (not shown) of the host computer that analyzes a change in quantity of light received by the light receiving element 64 to read positions of the register marks 56 printed on the surface of the medium 50, etc.

A register mark reader provided on the cutting plotter shown in FIGS. 1 to 3 is constructed in the aforementioned manner.

Subsequently, a preferred embodiment of a method of reading a register mark, according to the invention, using the register mark reader shown in FIGS. 1 to 3 will be described.

Also, in a first step in the method of reading a register mark, according to the invention, a medium 50, on which register marks 56 are printed together with a picture or/and a character 52 using the same software as that for printing of a picture or/and a character, of which a profile 54 is to be cut, is mounted on the platen 20 of the cutting plotter provided with the register mark reader, a register mark 56 indicative of an origin position of the picture or/and the character 52 printed on a surface of the medium 50 is caused to overlap an origin position of the platen 20, or near thereto, and a X-Y axis (axes extending from the register mark 56 indicative of the origin position toward register marks 56 positioned on the left or the right of and above or below the register mark) of the picture or/and the character 52 printed on the surface of the medium 50 is caused to overlap a X-Y axis (length and width) of the platen 20, or near thereto.

Specifically, that medium 50, which is mounted on a platen of a printer provided separately from the cutting plotter and on which a picture or/and a character 52, of which a profile 54 is to be cut, is printed together with register marks 56 using the same software, is moved to and mounted over on the platen 20 of the cutting plotter from the platen of the printer. By operating a jog key attached to the cutting plotter or the like, the medium 50 is moved an appropriate amount on the platen 20 of the cutting plotter in the X-Y axis (length and width). Then a register mark 56 indicative of the origin position of the picture or/and the character 52 printed on the surface of the medium 50 and printed leftwardly downward, or the like, on the surface of the medium 50 is caused to overlap the origin position of the platen 20 of the cutting plotter, or near thereto. Along with this, a X-Y axis (axes extending from the register mark 56 indicative of the origin position toward register marks 56 printed rightwardly downward and leftwardly upward on the surface of the medium 50) of the picture or/and the character 52 printed on the surface of the medium 50 is caused to overlap above or near a X-Y axis (length and width) of the platen 20.

Subsequently, in a second step, the retrieval means 100 of the register mark reader uses the same software as that for printing of a picture or/and a character to retrieve positional data of register marks 56 stored in data storage means 80 for printing of register marks and printed on the surface of the medium 50 together with the picture or/and the character 52 as shown in FIG. 4.

Subsequently, in a third step, the moving means 110 of the register mark reader overlaps a register mark 56, which is indicative of an origin position of the picture or/and the character 52 printed on the surface of the medium 50, on the origin position of the platen 20, or near thereto on the basis of positional data of register marks 56 retrieved by the retrieval means 100, overlaps a X-Y axis of the picture or/and the character 52 printed on the surface of the medium 50, on the X-Y axis of the platen 20, or near thereto, and moves the head 30 of the cutting plotter above the medium 50 mounted on the platen 20 of the cutting plotter relatively in the X-Y direction substantially in parallel to the surface of the platen 20. The head 30 is moved to above or near those locations on the surface of the medium 50 mounted on the platen 20, in which the register marks 56 are printed. At this time, since it is unnecessary for the optical sensor 60 mounted on the head 30 of the cutting plotter to recognize the register marks 56 printed on the surface of the medium 50, the head 30 of the cutting plotter is moved above the platen 20 to above or near those locations on the surface of the medium 50 mounted on the platen 20, in which the register marks 56 are printed, relatively in the X-Y direction at high speed without spending time on the basis of positional data of register marks 56 retrieved by the retrieval means 100.

Thereafter, in a fourth step, the head 30 having been moved to above or near those locations on the surface of the medium 50, in which the register marks 56 are printed, by the moving means 110 is moved above the platen 20 relatively in the X-Y direction with the use of the register mark read means 120 of the register mark reader at such a slow speed that the optical sensor 60 mounted on the head can surely recognize the register marks 56. Then the optical sensor 60 mounted on the head 30 is caused to surely recognize the register marks 56 printed on the surface of the medium 50 without oversight. On the basis of results of recognition by the optical sensor 60, positions of register marks 56 printed at four corners, etc. of the surface of the medium 50 as shown in FIG. 4 are surely analyzed and read at all times by an electronic circuit of the host computer or the like, which constitutes the register mark read means 120 of the register mark reader, without oversight.

The method of reading a register mark, according to the invention, using the register mark reader shown in FIGS. 1 to 3 comprises the first, second, third, and fourth steps.

In this manner, after positions of register marks 56 printed at four corners, etc. of the surface of the medium 50 are read, the host computer (not shown) drives the cutting plotter to correctly cut the profile 54 of the picture or/and the character printed on the surface of the medium 50 according to correct information, obtained from the positional information of the register marks 56, of an origin position of and inclination and elongation of the picture or/and the character 52 printed on the surface of the medium 50 mounted on the platen 20 of the cutting plotter in the X-Y direction, and on the basis of profile data of the picture or/and the character 52 stored in the data storage means 80 for printing of data of the picture or/and the character and printed on the surface of the medium 50 together with the register marks 56 with the use of the same software as that for printing of register marks.

### INDUSTRIAL APPLICABILITY

The register mark reader and the method of reading a register mark using the device, according to the invention, can be made effective use of in quickly and correctly cutting a profile of a picture or/and a character for sealing, poster, or the like, printed on a surface of a medium.

1. A cutting plotter, in which on the basis of that positional information of a register mark printed on a surface of a medium mounted on a platen, which is read by means of an optical sensor mounted on a head being moved above the platen substantially in paralel to a surface of the platen relatively in a X-Y direction, the head is moved above the platen substantially in the X-Y direction to permit a cutter mounted on the head to cut a profile of a picture or/and a character printed on the same surface of the medium as that, which is mounted on the platen and on which the register mark is printed,
the cutting plotter comprising
retrieval means that retrieves positional data of a register mark stored in data storage means for printing of the register mark and printed on the surface of the medium together with a picture or/and a character with the use of the same software as that for printing of the picture or/and the character, moving means, by which a register mark indicative of an origin position of the picture or/and the character printed on the surface of the medium is caused to overlap an origin position of, or near the platen on the basis of positional data of a register mark retrieved by the retrieval means, a X-Y axis of the picture or/and the character printed on the surface of the medium is caused to overlap a X-Y axis of, or near the platen to permit the head to move above the medium mounted on the platen relatively in the X-Y direction, and the head is moved to above or near that location on the surface of the medium mounted on the platen, in which the register mark is printed, and register mark read means, by which the head having been moved to above or near that location on the surface of the medium, in which a register mark is printed, by the moving means is moved above the platen relatively in the X-Y direction at such a speed that the optical sensor mounted on the head can recognize the register mark, and the optical sensor mounted on the head is used to read a position of the register mark printed on the surface of the medium.

2. A method of reading a register mark using the register mark reader according to claim 1, the method comprising
a first step, in which a medium having a register mark printed thereon together with a picture or/and a character, of which a profile is to be cut, is mounted on the platen of the cutting plotter to cause a register mark indicative of an origin position of the picture or/and the character printed on a surface of the medium to overlap an origin position of, or near the platen, and a X-Y axis of the picture or/and the character printed on the surface of the medium is caused to overlap a X-Y axis of, or near the platen,
a second step, in which the retrieval means uses the same software as that for printing of a picture or/and a character, of which a profile is to be cut by the cutting plotter, to retrieve positional data of a register mark stored in data storage means for printing of register marks and printed on the surface of the medium together with the picture or/and the character,
a third step, in which a register mark indicative of an origin position of the picture or/and the character printed on the surface of the medium is caused by the moving means to overlap the origin position of, or near the platen on the basis of positional data of a register mark retrieved by the retrieval means, a X-Y axis of the picture or/and the character printed on the surface of the medium is caused to overlap the X-Y axis of, or near the platen, and the head is moved above the medium mounted on the platen relatively in the X-Y direction to move the head to above or near that location on the surface of the medium mounted on the platen, in which the register mark is printed, and
a fourth step, in which the head having been moved to above or near that location on the surface of the medium, in which the register mark is printed, by the moving means is moved above the platen relatively in the X-Y direction with the use of the register mark read means at such a speed that the optical sensor mounted on the head can recognize the register mark, and the optical sensor mounted on the head is used to read a position of the register mark printed on the surface of the medium.
